(19) United States
(12) Patent Application Publication
(10) Pub. No.: US 2014/0213141 A1
(43) Pub. Date: Jul. 31, 2014

(54) Game Call Device

(71) Applicant: Harry Matthew Hassinger, Port Matilda, PA (US)

(72) Inventor: Harry Matthew Hassinger, Port Matilda, PA (US)

(21) Appl. No.: 13/750,100

(22) Filed: Jan. 25, 2013

(51) Int. Cl. A01M 31/00

(52) U.S. Cl. CPC A01M 31/004
USPC 446/188

(57) ABSTRACT

A turkey and game call device that is non-friction and/or water resistant with a bellows and reed arrangement to allow the operation of the call device with a single hand. The device also has a removable sounding chamber that allows the game call sound to create a wider and variable range of tones and volume.

### FIELD OF THE INVENTION

The present invention relates generally to turkey and game call devices. More particularly, non-friction and/or water resistant turkey game call devices with a bellows and reed arrangement to allow the operation of the call device with a single hand. The present invention has a removable sounding chamber that allows the game call sound to create a wider and variable range of tones and volume.

### BACKGROUND OF THE INVENTION

Turkey and game call devices have a sounder (also known as a voice box) and sounding chamber. The reed type call is operated by propelling air across the reed or multiple reeds to produce sounds which will stay constant in all types of weather, whereas many other turkey calls are rendered useless when exposed to moisture or water.

It is advantageous to consistently and easily produce several turkey call sounds with the same device such as the yelp, cluck, cutt, and cackle in all types of weather conditions. Conventional friction type turkey call arrangements usually require the use of both hands to operate and do not provide a convenient or reliable way to produce multiple call sounds in all weather conditions.

### SUMMARY OF THE INVENTION

The instant invention has a hollow call body. The hollow body holds a reed sounder. The sounder is held in place either within a hollow elastomeric sleeve and metal sleeve or the reed sounder is in direct contact with the call body inner surface. The hollow elastomeric sleeve is in contact with the inner surface of the call body, and within the hollow elastomeric sleeve is a metal sleeve that is in contact with the inner surface of the hollow elastomeric sleeve. The sounder is a reed or multiple reed and a holder portion that is snugly fit within the metal sleeve inner surface or call body inner surface.

A bellows is removably attached to a first end of the call body and a sound chamber is removably attached to the second end of the call body which produces a sound that some users would perceive as a more realistic and natural sound.

The bellows and sound chamber along with the call body protects the reed sounder from the elements preventing items such as, but not limited to, dirt, sticks and water from entering the call and damaging the reed sounder. If the reeds were to become wet, the air forced over the reeds would dry it quickly making the call water resistant while still maintaining proper sound. Other styles and types of turkey calls are rendered less effective when their primary sounders are exposed to moisture, in fact, most all friction type calls are rendered useless by moisture, thus making this particular non-friction type call preferred.

In operation, the user can tap, push or more forcibly depress the bellows in many ways to conveniently and constantly produce multiple turkey call sounds such as yelps, cackles, cutts and clucks. Alternatively, the user can remove the bellows end and blow air through the call to operate it.

An object of the invention is to produce multiple turkey call sounds such as yelps, clucks, cutts, and cackles consistently during dry and wet weather conditions.

Yet another object is to provide a removable sounding chamber.

A further object is to allow the user with experience from novice to expert to produce realistic sounds with little effort or practice.

The novel features of the present invention are set forth in the claims herein. The functionality, modes of operation, purposes, and advantages of this invention can be further understood with reference to the following drawings and description of the preferred embodiment.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 is a exploded view of the improved turkey call device.

FIG. 2 is an exploded view of the sounder and holder assembly.

FIG. 3 is a perspective view of the sounder.

FIG. 3A is a close up of the end portion of the sounder of FIG. 3.

### DETAILED DESCRIPTION OF THE PREFERRED EMBODIMENT

An improved game call device 10 having a hollow call body 12 with a first end 14 and a second end 16. Preferably, the hollow interior shape of the call body 12 has a circular cross-section perpendicular to the longitudinal axis of the call body 12, and forms a call body inner tube.

The first end 14 of the call body 12 preferably has a circular cross-section. Near the first end 14 of the call body 12 on the exterior surface is a groove 18 recessed in the exterior surface thereof. The second call body end 16 has an exterior groove 17 near the end thereof.

The interior surface 20 of the hollow call body 12 has a holder assembly 30. The holder assembly 30 has an outer sleeve 32 that is preferably manufactured of an elastomeric material such as plastic or rubber, and an inner sleeve 34 that is preferably manufactured of metal or plastic. The holder assembly 30 has shape that corresponds to the interior surface 20 of the call body 12, and forms a holder assembly inner tube. The holder assembly 30 fits snugly and is in contact with the interior surface of call body 12.

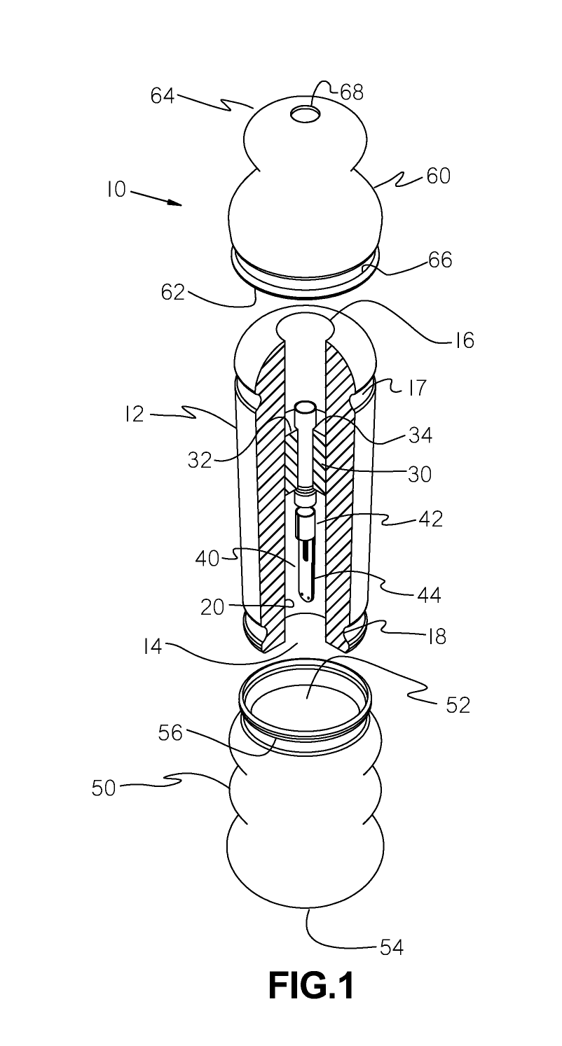

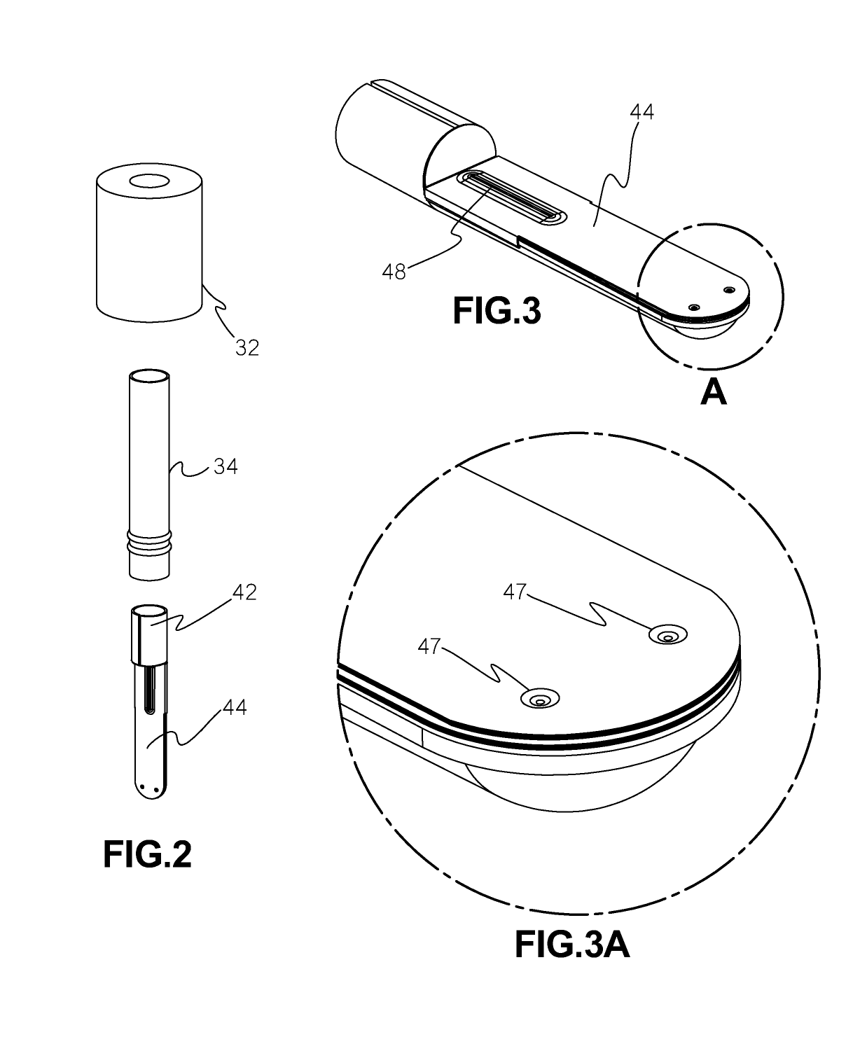

A sounder 40 has a sounder holder portion 42 and a reed portion 44. The sounder 40 may include single or multiple reeds. Each reed is preferably manufactured from MYLAR, vinyl, plastic, wood, or metal. When incorporating two reeds, as illustrated in the preferred embodiment of FIGS. 1, 2, 3, and 3A, the reeds are placed parallel to one another and spaced apart so as to vibrate when air passes therethrough. At least one reed includes at least one dimple 47 adapted to hold the reeds in a spaced configuration, such that air may always pass therethrough and each reed is capable of vibrating individually. Another important feature is grooves 48 that are created on the portion of each reed adjacent to the holder portion. These grooves are adapted to modify the sound created by the sounder such that it appears to sound similar to the sound of a turkey call. These grooves can be created by inserting a pin or like structure in between existing reeds, deforming the reeds, and then removing the pin leaving curved, elongated grooves in each reed. The holder portion 42 further includes a base that extends in between and along a length of the reeds. The reed portion 44 is substantially flat and the base of the holder portion 42 may have a slight slope that can allow air to be funneled around the reed portion 44. The holder may have an arch shape so that air can pass between the holder portion 42 and reed portion 44. The sounder 40 is fit snugly inside the interior surface of the holder assembly 30.

A hollow bellows 50 has a first open end 52 and a second closed end 54. The bellows 50 has a lip 56 on the interior surface of the bellows 50 near the first open end 52. The lip 56 corresponds and mates with the groove 18. The lip and groove arrangement can of course be reversed. The bellows 50 is adapted to snap onto call body 12. The call 10 has at least one bellow 50.

A hollow sound chamber 60 has a first end 62 and a second end 64. The sound chamber 60 preferably has a bell shape. Sound chamber 60 has a lip 66 on an interior surface generally near the first end 62. The lip 66 corresponds to the groove 17. The sound chamber 60 is removably attached to call body 12. The sound chamber 60 has at least one orifice 68 at or near the second end 64. The purpose of the at least one orifice 68 is to permit the air to enter and to escape the call body 12. The sound chamber 60 may have more than one orifice 68. The bellow 50, call body 12 and sound chamber 60 are in fluid communication.

In second embodiment, not shown, the sounder holder portion 42 is directly in snug in contact with the interior surface 20 of call body 12 without the use of holder assembly 30.

In a third embodiment, not shown, a plastic sleeve 32 is used without a metal sleeve 34 in place of an assembly 30.

In fourth embodiment, not shown, the sound chamber 60 is attached in a threaded arrangement to call body 12, wherein the opposing threads and grooves are preferably positioned in place of the groove 17 and lip 66.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A game call device comprising an elongated hollow call body having a first end and an opposite second end, and having a circular cross-section forming a call body inner tube; a hollow sound chamber removably attached to said second end of said call body, and having at least one orifice therein; and a hollow bellows removably attached to said first end of said call body, such that when said bellows is compressed air is forced through said call body and said sound chamber creating a game calling sound of a turkey.

2. The game call device of claim 1, wherein said call body further includes a sounder adapted to fit snugly inside said call body inner tube, said sounder comprising a holder portion, and a reed portion attached to said holder portion and including at least one reed, such that when said air passes therethrough said at least one reed vibrates creating a sound.

3. The game call device of claim 2, wherein said reed portion includes two reeds spaced apart from one another; and wherein each reed has a groove along a length thereof adapted to modify said sound created by said reeds.

4. The game call device of claim 3, wherein said reed portion has a base having a surface that is angled with respect to elongated parallel surfaces of said reeds, such that it is adapted to funnel air around said reed portion.

5. The game call device of claim 2, further comprising a holder assembly adapted to fit in between an inner surface of said call body inner tube and said sounder, wherein said holder assembly has a circular cross-section forming a holder assembly inner tube, and wherein said sounder is adapted to fit snugly inside said holder assembly inner tube, to thereby hold said sounder more securely inside said call body inner tube, and make it easier to remove and repair or change said sounder.

6. The game call device of claim 1, wherein said sound chamber is formed in the shape of a bell, to thereby modify said game calling sound.

7. The game call device of claim 1, wherein said sound chamber has a first end and a second opposite end, a circumferential lip located on an inner surface of said first end, and wherein said orifice is located on said second end; and wherein said call body includes a circumferential groove near said second end, such that said second end groove is adapted to frictionally and releasably hold said sound chamber lip therein.

8. The game call device of claim 7, wherein said bellows has a first end and a second opposite end, and a circumferential lip located on an inner surface of said first end, and wherein said call body includes a circumferential groove near said first end, such that said first end groove is adapted to frictionally and releasably hold said bellows lip therein.

9. The game call device of claim 5, wherein said holder assembly comprises an outer sleeve and an inner sleeve, to thereby provide the option of forming said sleeves from different materials.

10. The game call device of claim 9, wherein said holder assembly outer sleeve is formed from a rubber material; and said holder assembly inner sleeve is formed from metal material.

11. The game call device of claim 2, wherein said at least one reed is formed from a material that is chosen from a list of materials that comprises MYLAR, vinyl, plastic, wood, and metal.

12. The game call device of claim 1, wherein said device is 5.5 inches in length and 1.25 inches in diameter.

13. The game call device of claim 3, wherein at least one of said two reeds includes at least one dimple at a distal end opposite said base, wherein said at least one dimple is adapted to hold said reeds in a spaced configuration, such that air may always pass therethrough and each reed is capable of vibrating individually.

14. The game call device of claim 3, wherein said holder portion further includes a base that extends in between and along a length of said reeds.
